(19) United States
(12) Patent Application Publication
(10) Pub. No.: US 2009/0207302 A1
(43) Pub. Date: Aug. 20, 2009

(54) METHOD AND APPARATUS TO MEASURE FEATURES IN A CONDUIT

(76) Inventors: Chris Neffendorf, Benbrook, TX (US); Randy C. Barber, Grand Junction, CO (US)

Correspondence Address: FULBRIGHT & JAWORSKI, LLP, 1301 MCKINNEY, SUITE 5100, HOUSTON, TX, 77010-3095, US

(21) Appl. No.: 12/031,072

(22) Filed: Feb. 14, 2008

(51) Int. Cl. H04N 5/225

(52) U.S. Cl. 348/373

(57) ABSTRACT

A system and method for measuring the size and orientation of anomalies on the interior surface of a conduit. The system and method can include a camera housed in a centralizer and a means for providing measurement markers within the field of view of the camera. The system and method can also include an orientation sensor for determining the orientation of the anomaly within the conduit.

### TECHNICAL FIELD

The invention relates generally to a method and apparatus for measuring features on the interior surface of conduits, and more particularly to a method and apparatus for measuring anomalies on the interior of a wellbore.

### BACKGROUND OF THE INVENTION

Measuring features on the internal surface of a conduit can be important in many industries such as the oil and gas industry where pipes, casing, and the like may require internal measurement. For example, conduits may suffer deformations such as cracks, corrosion, separation from adjoining conduits, bends, obstructions, etc., and precise measurement of these deformations is important for safety and productivity. As a particular example, in the drilling industry wellbores are drilled in the earth's surface and lined with casing, and the casing is perforated to permit flow of formation fluids. Measurement of these perforations is important for safety and productivity.

U.S. Pat. No. 5,652,617 discloses an apparatus and method for visually examining the sidewalls of a borehole for anomalies. The apparatus, including a camera, is lowered down hole by cable from a surface winch, and measurement of the anomalies is made by noting the comparative length of cable let down from the winch. Such a device has limited utility, especially when precise measurement of anomalies is required. For example, when lowering the device by cable, the device may drag in the wellbore, leading to a false measurement of depth at the surface winch. Similarly, when raising the device, the cable may stretch, again leading to false measurement of depth at the surface winch. In addition, when a wellbore or pipe is not directly vertical, imprecision in measurements can result.

The industry needs a simple and cost effective method and apparatus to measure anomalies on the interior surface of cylindrical conduits.

### BRIEF SUMMARY OF THE INVENTION

In one embodiment of the invention, an apparatus comprises a centralizer with circumferentially spaced legs that can be placed in a conduit and a camera housed within the centralizer with a field of view oriented generally radially from the longitudinal axis of the conduit such that the camera can view markings of known dimension placed on the inside of the centralizer legs to facilitate measuring features on an internal surface of the conduit.

In another embodiment of the invention, an apparatus comprises a centralizer with circumferentially spaced legs that can be placed in a conduit, a camera connected to the centralizer with a field of view oriented generally radially from the longitudinal axis of the centralizer such that a caliper arm connected to the centralizer can hold a measurement strip within the camera's field of view to facilitate measuring features on an internal surface of the conduit.

In some embodiments, the apparatus may include further comprising a connector for connecting the centralizer to a surface station.

In another embodiment of the invention, an apparatus comprises an elongate member that can be placed in a conduit, a connector for connecting the elongate member to a surface station, a camera connected to the elongate member with a field of view oriented generally radially from the longitudinal axis of the elongate member, and at least one high-intensity light-generating device connected to the elongate member that can project at least two parallel beams separated by a constant longitudinal distance on an internal surface of the conduit such that the projected beams are viewable by the camera.

In some embodiments, the elongate member is connected to a centralizer.

In another embodiment of the invention, a method comprises positioning a camera within the conduit, the camera having a field of view oriented generally radially from the longitudinal axis, locating an anomaly in the conduit and bringing the anomaly within the field of view of the camera, a step for positioning measurement markers adjacent to the anomaly, and capturing an image of the anomaly and the measurement markers.

In some of the embodiments, the method includes positioning the camera within a centralizer having a plurality of circumferentially spaced legs, having measurement markers on the side of the legs facing the longitudinal axis, and positioning the measurement markers on one of the legs adjacent the anomaly.

In other embodiments, the method includes providing a caliper arm to a hold a measurement strip within the field of view of the camera.

In other embodiments, the method includes shining a plurality of parallel high-intensity light beams from a high-intensity light-generating device connected to the camera within the field of view of the camera, the beams being separated by a known dimension.

In some embodiments, the method includes connecting the camera to a surface station.

In any of the embodiments, the camera may be rotatable about a longitudinal axis, and the camera can be at least any of the following types: a photographic camera, a video camera, a color camera, a black and white camera, a CCD camera, a CMOS camera, a panoramic camera, and any combination thereof. In any of the embodiments, the apparatus may include a light source for the camera, and the light source can be at least any of the following types: LED, fiber optic, filament, halogen, chemical, and any combination thereof.

In any of the embodiments, the apparatus may further include an orientation sensor connected to the camera and/or centralizer to help determine the orientation of the camera. The orientation sensor can be at least any of the following types: a second camera with a field of view oriented generally downward along the longitudinal axis, a pressurized two-fluid container, a gyroscope, a compass, an inclinometer, and any combination thereof. In some embodiments, the orientation sensor is connected to the centralizer and viewable by a second camera.

In embodiments with a connector, the connector may be at least cable, wireline, or coiled tubing. In embodiments with a centralizer with legs, the legs may maintain the camera substantially about the conduit's longitudinal axis and may be adjustable to accommodate different diameter conduits. The centralizer may have any number of legs, such as four, six, or eight legs, for example.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a schematic view of an apparatus representing one embodiment of the present invention;

FIG. 2 is a detail view of a portion of an apparatus representing one embodiment of the present invention;

FIG. 3 is a detail view of a portion of an apparatus in a conduit representing one embodiment of the present invention;

FIG. 4 is a view of a portion of an apparatus and surroundings as seen from a side-view camera representing one embodiment of the present invention;

FIG. 5 is a detail view of a portion of an apparatus including an orientation sensor representing one embodiment of the present invention;

FIG. 6 is a schematic view of an apparatus representing another embodiment of the present invention;

FIG. 7 is a schematic view of an apparatus representing another embodiment of the present invention.

### DETAILED DESCRIPTION OF THE INVENTION

As used herein, the use of the word “a” or “an” when used in conjunction with the term “comprising” (or the synonymous “having”) in the claims and/or the specification may mean “one,” but it is also consistent with the meaning of “one or more,” “at least one,” and “one or more than one.” In addition, as used herein, the phrase “connected to” means joined to or placed into communication with, either directly or through intermediate components.

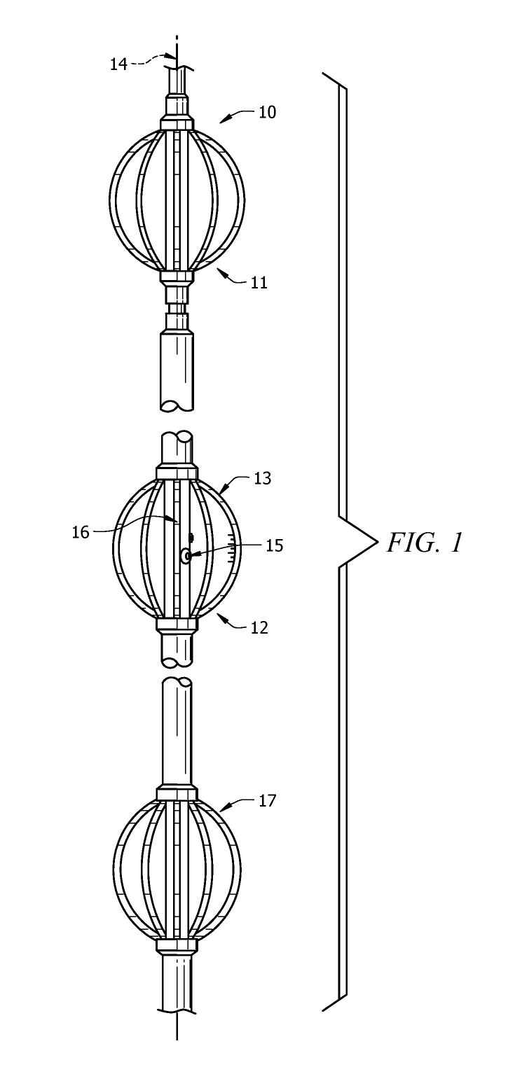

Referring to FIG. 1, one embodiment of the present invention comprises conduit measuring device 10 comprising an upper centralizer 11 and a lower centralizer 12. Each centralizer has a plurality of circumferentially spaced legs 13 that serve to push against the internal side of a conduit and thus to orient device 10 substantially along longitudinal axis 14. At least one of the centralizers, (in this embodiment it is lower centralizer 12) contains camera 15 housed within it. Camera 15 may be housed within the centralizer in any way known in the art, such as on central elongate member 16. In some embodiments, upper centralizer 11 is not needed, and only centralizer 12 is used. In other embodiments, an additional centralizer 17 is included below centralizer 12.

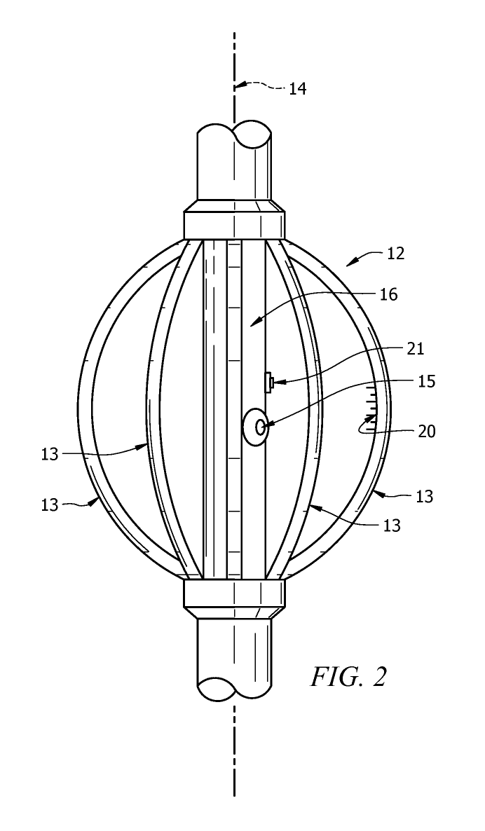

Referring to FIG. 2, camera 15 is oriented to view the right side of the drawing and is facing one of the circumferentially spaced legs 13. Measurement marks 20 appear on the inside of circumferentially spaced legs 13 (that is, on the side facing axis 14), and are shown for purpose of illustration to be raised marks. Of course, marks 20 need not be raised, but may be painted, drawn, etched, or otherwise placed on legs 13. Marks 20 are of known dimension, such as may be found on a ruler with inches, centimeters, etc. Marks 20 serve as a convenient reference to measure anomalies appearing near legs 13, when camera 15 captures both the anomaly and marks 12 in an image.

Camera 15 may be rotatable with respect to legs 13 about longitudinal axis 14, with rotation accomplished by rotation of central elongate member 16, or by rotation of any housing or carrier to which camera 15 is attached. Rotation of camera 15 permits it to view all 360 degrees of the inside of any conduit in which it is placed. Camera 15 may be any camera known in the art, including black and white or color, photographic or video, CCD, CMOS, panoramic or the like. In some embodiments, camera 15 does not rotate 360 degrees, but a plurality of cameras are placed to provide a 360 degree view.

A light source 21 may provide light for camera 15 and may be any light source known in the art, including LED, fiber optic, filament, halogen, chemical, etc. Light source 21 may be rotatable in a manner similar to camera 15 to rotate therewith, or a plurality of stationary light sources 21 may provide adequate light.

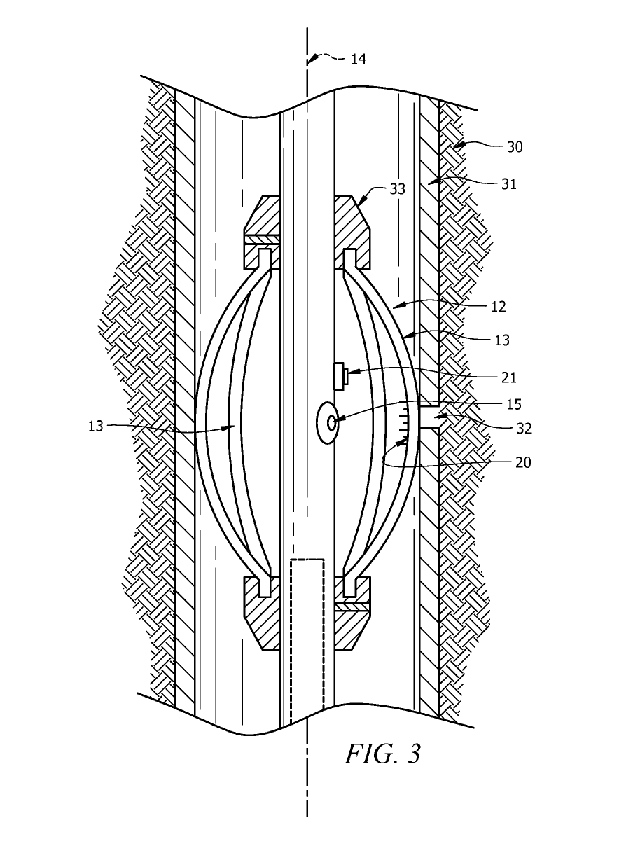

Referring to FIG. 3, centralizer 12 is depicted inside a conduit. Although FIG. 3 shows the device 10 inside of casing 31 surrounded by wellbore earth 30, the conduit may also be a pipe, pipeline, marine riser, etc. Regardless, the device and particularly camera 15 is shown to have been brought into alignment with anomaly 32, which may be, for example, of perforation, tear, separation, rust-damaged area, dent, or obstruction. As depicted, anomaly 32 is a perforation, and can be measured by camera 15 with reference to marks 20 on legs 13.

Note that legs 13 have compressed somewhat from contact with casing 31. Such contact keeps centralizer 12 aligned with the center of casing 31. If either or both of centralizers 11 or 17 (see FIG. 1) are included, they can provide additional centralization and stabilization. Legs 13 may attach to collar 33, which can be adjustable about longitudinal axis 14 to accommodate different pipe diameters.

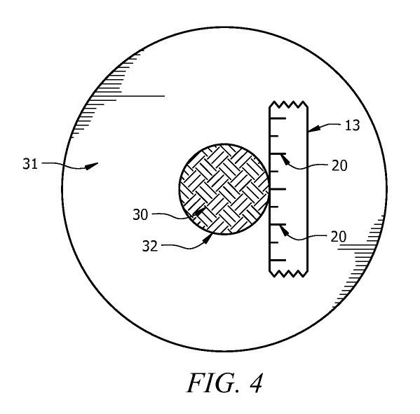

Referring to FIG. 4, an image of anomaly 32 as seen by camera 15 shows wellbore earth 32 through the hole created by anomaly 30. A portion of one of legs 13 appears to the right of anomaly 32, and markers 20 on leg 13 provide for measurement of anomaly 32. While anomaly 32 is shown as a substantially round hole, as might be found with a perforation, anomaly 32 could of course be any type of deformation.

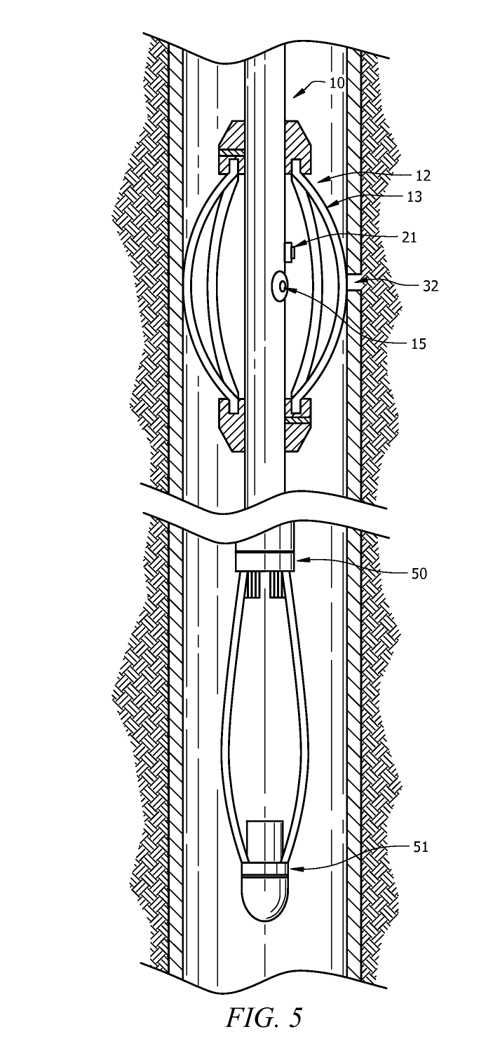

Referring now to FIG. 5, in some embodiments a down hole camera 50 is added to the bottom of device 10 and is oriented generally down the conduit. Down hole camera 50 provides an additional broader view of the conduit and can aid in viewing and locating anomalies. In one embodiment, down hole camera 50 can serve as an orientation sensor, especially in angled or horizontal wells, by viewing debris (such as sand) left on the bottom of the casing.

In another embodiment, camera 50 is operably connected with an orientation sensor 51 such that camera can capture images of sensor 51. For example, orientation may comprise a pressurized two-fluid container, which can be used to determine orientation based on separation of the immiscible fluids of different density. Such a device is especially useful in horizontal or angled wells. In another embodiment, orientation sensor 51 comprises a gyroscope, which can be used to determine orientation based on its spinning axis. In still another embodiment, orientation sensor 51 comprises an inclinometer. In still another embodiment, orientation sensor 51 comprises a compass. Combinations of the camera, two-fluid container, gyroscope, compass, and/or inclinometer are also possible.

Of course the additional camera 50 and/or orientation sensor 51 need not be placed at the down hole end of device 10, but may be placed anywhere along the tool, including in centralizer 12, centralizer 11 (if present), centralizer 17 (if present), or near any of the preceding. In some embodiments, orientation sensor 51 is not viewable by second camera 50, second camera 50 can be omitted, and sensor 51 may store and/or relay orientation data to computers and/or users by analog, digital, or electronic means as is known to those skilled in the art. One of the main purposes of orientation sensor 51 is to provide data to determine the location of the anomaly within the 360 degree circumference of the interior of the conduit.

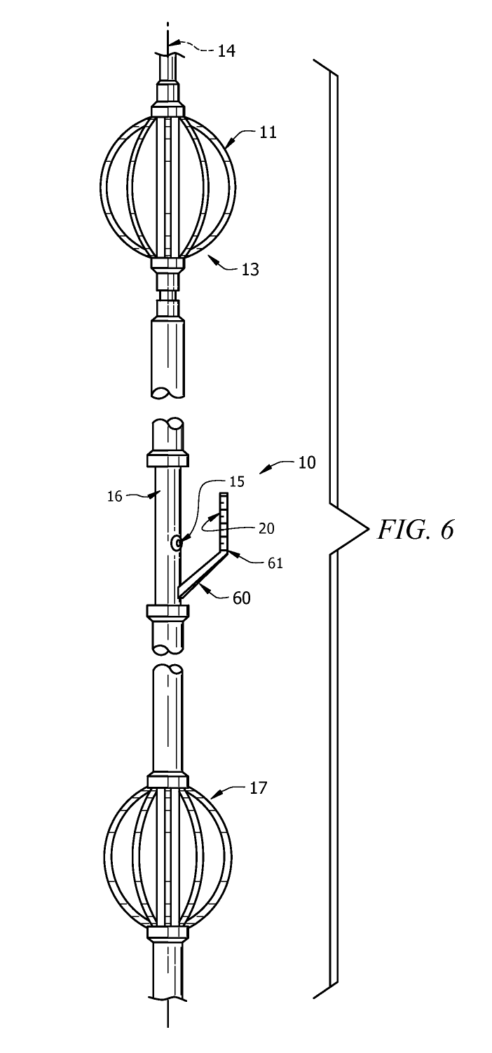

Referring to FIG. 6, another embodiment of the present invention comprises conduit measuring device 10 comprising an upper centralizer 11 having a plurality of circumferentially spaced legs 13. Central elongate member 16 extends from centralizer 11 along axis 14 and is attached to camera 15, which camera is similar to that described above in other embodiments. While elongate member is depicted as cylindrical, it may generally be any shape. In this set of embodiments, caliper arm 60 is connected to central elongate member 16 and is operable to hold measurement strip 61 in the field of view of camera 15. Measurement strip 61 contains marks 20 as described above. Like camera 15, caliper arm 60 may rotate about axis 14, or it may be stationary. In some embodiments, to provide quick and accurate measurements of anomalies, caliper arm 60 is operable to hold strip 61 at or near the surface or anomaly to be measured so that little or no relative distance exists between the surface to be measured and strip 61 to distort measurement. Optionally, an additional centralizer 17 is included along axis 14 on the side of camera 15 opposite centralizer 11. In some embodiments, camera 15 and strip 61 do not need to be housed inside a centralizer, which can be helpful to provide more viewing freedom from camera 15. In other embodiments using caliper arm 60, it may be useful to have camera 15 inside a centralizer. Of course, additional camera 50 and/or orientation sensor 51 may be provided to this set of embodiments as described previously.

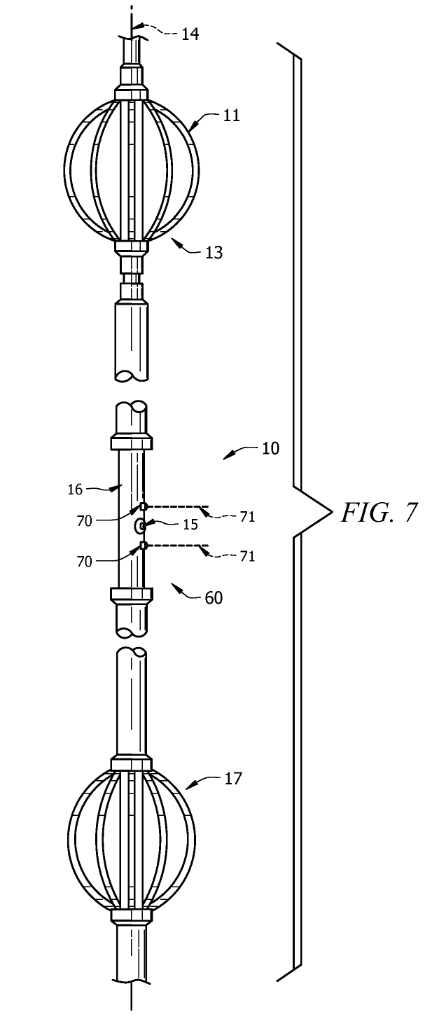

Referring to FIG. 7, another embodiment of the present invention comprises conduit measuring device 10 comprising central elongate member 16 attached to camera 15, which camera is similar to that described above in other embodiments. Central elongate member 16 is attached to high-intensity light generating device 70, which generates a plurality of parallel high-intensity light beams 71 to shine on and/or near the surface to be viewed by camera 15. High-intensity light beams 71 may be laser lights or other similar beams that do not diverge appreciably over the distance from the laser to the inside of the conduit, which for the uses of device 10, include in some embodiments about 5 feet or less, in other embodiments about one foot or less, and in other embodiments about six inches or less. Because high-intensity light beams 71 are parallel to each other, they will serve to mark points or shapes on the conduit of a known distance from each other regardless of distance traveled. Thus, high-intensity light beams 71 permit easy measurement of anomalies viewed by camera 15. High-intensity light beams 71 can project dots, lines, or any shape to facilitate measurement. Of course, additional camera 50 and/or orientation sensor 51 may be provided to this set of embodiments as described previously.

Although FIG. 7 depicts high-intensity light generating device 70 as located on both sides of camera 15, it of course may be above or below camera 15. Likewise, while the beams 71 are depicted as travelling at a right angle with respect to axis 14, they can, in some embodiments travel at any angle to axis 14, for instance where elongate member 16 is held parallel to axis 14. High-intensity light generating device 70 may rotate with camera 15, or a plurality of devices 70 may be installed to provide adequate circumferential coverage to allow measurement of the conduit surface's circumference. In the set of embodiments involving high-intensity light generating device 70, no centralizers are required because parallel high-intensity light beams 71 will provide accurate measurement regardless of orientation. Optionally, however, centralizer 11 having axis 14 and a plurality of circumferentially spaced legs 13 is connected to central elongate member 16, and in some embodiments, an additional centralizer 17 is included along axis 14 on the side of camera 15 opposite centralizer 11.

In use, the device 10 described in any of the above embodiments may be connected to an area outside the conduit, such as a surface station, by a connector and lowered or maneuvered into a conduit by any means known in the art. For example, the connector may comprise cable, wireline, coiled tubing, or the like. The device 10 is maneuvered into a conduit and brought to a position whereby camera 15, perhaps after rotation, can view an anomaly. In addition, camera 15 must also be able to view one of the measurement means described above. Camera 15 then captures an image or images of the anomaly and the measurement means and stores or transmits the image or images such that the dimensions of the anomaly may be determined. During this process, orientation sensor 51 may provide visual and/or mathematical data by which the orientation of the anomaly is determined. Other optional steps include providing a light source for camera 15 to facilitate better images and providing a down hole camera to provide additional views of the conduit. Such a camera may be used to help locate anomalies.

Some of the embodiments have been described for convenience with respect to perforations in a wellbore, but the invention will work in a variety of embodiments for a variety of environments. The invention will work for any generally cylindrical conduit for which measurement of features on the interior surface is desired.

As can be seen from the above description of certain embodiments of the present invention, the invention offers an inexpensive and efficient way measure features on the interior surface of a conduit. Such a system and method does not rely broadly on estimates and mathematical models to achieve measurement, but rather on direct or nearly direct measurement.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. An apparatus, comprising:
a centralizer with circumferentially spaced legs operable to be placed in a generally cylindrical conduit, the centralizer having a longitudinal axis;
a camera housed within the centralizer with a field of view oriented generally radially from the longitudinal axis and toward the legs, wherein the legs have inner surfaces oriented generally toward the longitudinal axis that are marked with markings of known dimension to facilitate measuring features on an internal surface of the conduit.

2. The apparatus of claim 1, wherein the camera is rotatable about the longitudinal axis.

3. The apparatus of claim 1, wherein the camera is selected from the group consisting of a photographic camera, a video camera, a color camera, a black and white camera, a CCD camera, a CMOS camera, a panoramic camera, and any combination thereof.

4. The apparatus of claim 1, wherein the legs maintain the camera substantially about the longitudinal axis and are adjustable to accommodate different diameter conduits.

5. The apparatus of claim 1, further comprising a light source for the camera.

6. The apparatus of claim 5, wherein the light source is selected from the group consisting of LED, fiber optic, filament, halogen, chemical, and any combination thereof.

7. The apparatus of claim 1, further comprising an orientation sensor connected to the centralizer operable to help determine the orientation of the camera.

8. The apparatus of claim 7, wherein the orientation sensor is selected from the group consisting of a second camera with a field of view oriented generally downward along the longitudinal axis, a pressurized two-fluid container, a gyroscope, a compass, an inclinometer, and any combination thereof.

9. The apparatus of claim 7, wherein the orientation sensor is connected to the centralizer and viewable by a second camera and is selected from the group consisting of a pressurized two-fluid container, a gyroscope, a compass, and any combination thereof.

10. The apparatus of claim 1, further comprising a connector for connecting the centralizer to a surface station.

11. The apparatus of claim 10, wherein the connector is selected from the group consisting of cable, wireline, and coiled tubing.

12. The apparatus of claim 1, further comprising six of the circumferentially spaced legs, wherein the legs are spaced equally apart from each other.

13. An apparatus, comprising:
at least one centralizer with circumferentially spaced legs operable to be placed in a generally cylindrical conduit, the centralizer having a longitudinal axis;
a camera connected to the centralizer with a field of view oriented generally radially from the longitudinal axis and toward an inner surface of the cylindrical conduit;
a caliper arm connected to the centralizer operable to hold a measurement strip within the camera's field of view to facilitate measuring features on an internal surface of the conduit.

14. The apparatus of claim 13, further comprising an orientation sensor connected to the centralizer operable to help determine the orientation of the camera.

15. The apparatus of claim 13, further comprising a light source for the camera.

16. The apparatus of claim 13, further comprising a connector for connecting the centralizer to a surface station.

17. An apparatus, comprising:
an elongate member operable to be placed in a conduit, the elongate member having a longitudinal axis;
a connector for connecting the elongate member to a surface station;
a camera connected to the elongate member with a field of view oriented generally radially from the longitudinal axis;
one or more high-intensity light-generating devices connected to the elongate member operable to project parallel high-intensity beams separated by a constant longitudinal distance on an internal surface of the conduit, wherein the projected beams are viewable by the camera.

18. The apparatus of claim 17, wherein the elongate member is connected to a centralizer.

19. The apparatus of claim 17, further comprising an orientation sensor connected to the elongate member operable to help determine the orientation of the camera.

20. A method for measuring anomalies on an interior of a conduit having a longitudinal axis, comprising:
positioning a camera within the conduit, the camera having a field of view oriented generally radially from the longitudinal axis;
locating an anomaly in the conduit;
bringing the anomaly within the field of view of the camera;
a step for positioning measurement markers adjacent to the anomaly; and
capturing an image of the anomaly and the measurement markers.

21. The method of claim 20, further comprising positioning the camera within a centralizer having a plurality of circumferentially spaced legs; and
providing measurement markers on the side of the legs facing the longitudinal axis,
wherein the step for positioning comprises positioning the measurement markers on one of the legs adjacent the anomaly.

22. The method of claim 20, further comprising determining the orientation of the anomaly using an orientation sensor.

23. The method of claim 20, further comprising connecting the camera to a surface station.

24. The method of claim 20, wherein the step for positioning comprises
providing a caliper arm to a hold a measurement strip within the field of view of the camera.

25. The method of claim 20, wherein the step for positioning comprises shining a plurality of parallel high-intensity light beams from a high-intensity light-generating device connected to the camera within the field of view of the camera, the beams being separated by a known dimension.
